(19) United States
(12) Patent Application Publication
(10) Pub. No.: US 2006/0239304 A1
(43) Pub. Date: Oct. 26, 2006

(54) High powered TEM00 mode pulsed laser

(75) Inventors: Yusong Yin, Stonybrook, NY (US); Graham Ross, North Babylon, NY (US)

Correspondence Address: JAMES A. QUINTON, Suite 1210, 551 Fifth Avenue, New York, NY, 10176, US

(73) Assignee: Photonics Industries Int'l

(21) Appl. No.: 11/112,232

(22) Filed: Apr. 23, 2005

(51) Int. Cl. H01S 3/098; H01S 3/11; H01S 3/04; H01S 3/091; H01S 3/08; H01S 3/092

(52) U.S. Cl. 372/19; 372/10; 372/70; 372/34; 372/36; 372/101

(57) ABSTRACT

A high power pulsed laser having a Q-switched seed laser lasing at a preselected wavelength at TEM₀₀ mode to produce a pulsed seed beam is disclosed. One or more substantially non-depolarizing optical amplifier media namely Nd:YVO₄ or Nd:GVO₄ crystals are used in optical communication with the seed laser. The optical amplifier media has a stimulated emission spectrum overlapping the preselected wavelength. A pumping source is provided in optical communication with the optical amplifier media to supply 15 watt or more of pumping power to excite the amplifier media and amplify the pulsed seed beam. The resulting laser produces 15 watts or greater of output power at the preselected wavelength. A temperature controller is desirably provided to regulate the temperature of the optical amplifier medium within a preselected range selected to enhance the amplification of the seed beam by increasing the degree of overlap between the stimulated emission spectrum and the seed beam wavelength.

### FIELD OF THE INVENTION

The invention relates to high power pulsed amplified lasers.

### BACKGROUND OF THE INVENTION

Master oscillator power amplifier (MOPA) having an output of 15 watts or more is desired in the art. Generally for pulsed high power applications the reliable Nd:YAG laser was used both as the seed laser and amplifier. Typically such seed lasers were matched with Nd:YAG amplifiers since there were no problem with overlapping stimulated emission spectrum. Moreover Nd:YAG crystals were used as an amplifier for single longitudinal mode applications because of the large size and high quality of available Nd:YAG crystals. However such lasers suffered from mode distortion. Thermal lensing in the Nd:YAG crystals induced depolarization which prevented achieving high repetition rates and high average power at TEM₀₀ or diffraction limited modes. Nd:YVO₄ amplifiers have been proposed for use with Nd:YAG seed lasers in low power applications; however they have been considered limited to applications requiring pumping at 2 watts or less due to thermal effects and to complicated multipass configuration. Two (2) watts of pumping power is insufficient for pulsed high power applications. See U.S. Pat. No. 6,373,864 (Georges). Efforts to provide higher power amplified lasers often employed complex multipass systems. There is still a need in the art for higher power simple single pass pulsed amplified lasers.

### SUMMARY OF THE INVENTION

According to the invention a single pass pulsed high power laser is provided. Single pass amplified lasers are desired due to the simplicity, efficiency and reliability of such lasers. According to the invention, the laser includes a Q-switched seed laser lasing at a preselected wavelength at TEM₀₀ mode having a mode quality M²<2 to provide a pulsed seed beam. One or more substantially non-depolarizing optical amplifier media for example a Nd:YVO₄ crystal is provided in optical communication with the seed laser. The optical amplifier media has a stimulated emission spectrum overlapping the preselected wavelength. A pumping source for example diodes is provided in optical communication with the optical amplifier media to supply 15 watts or more of pumping power to excite the amplifier media and amplify the pulsed seed beam. The resulting laser produces 15 watts or greater of output power at the preselected wavelength from a single pass of seed beam. The laser has a simple design and does not require complicated multiple pass configurations. Thermal depolarization problems encountered with Nd:YAG amplifier are avoided.

In another aspect of the invention, a temperature controller is provided to regulate the temperature of the optical amplifier medium within a preselected range selected to enhance the amplification of the seed beam by increasing the degree of overlap between the stimulated emission spectrum and the seed beam wavelength.

It is an object of the invention to provide a pulsed high power TEM₀₀ mode laser having a single pass of seed beam through amplifier medium. It is an object of the invention to provide a pulsed high power TEM₀₀ mode laser having reduced mode distortion.

It is an object of the invention to provide an amplified Q-switched pulsed high power laser having a power output of 15 watts or greater at TEM₀₀ mode.

It is an object of the invention to provide an amplified pulsed high power laser having a power output of 50 watts or greater at TEM₀₀ mode.

It is an object of the invention to provide an amplified pulsed high power laser having a power output of 15 watts or greater at TEM₀₀ mode and having a single longitudinal mode.

It is an object of the invention to provide a multistage amplified pulsed high power laser in which each stage is pumped with 15 watts or more of pumping power.

It is an object of the invention to provide a multistage amplified pulsed high power laser in which each stage is pumped with 25 watts or more of pumping power.

It is an object of the invention to overcome the thermal depolarization problems encountered with pulsed high power amplified lasers using Nd:YAG based amplifiers.

It is an object of the invention to provide a pulsed high powered laser having an amplifier that can accommodate a variety of seed lasers.

It is an object of the invention to reduce the number of passes in a pulsed high powered amplifier.

It is an object of the invention to provide pulsed high power reliable single pass amplifiers.

It is an object of the invention to provide a simple modular amplifier that can have its power raised substantially proportional to the number of modules.

It should be understood that each embodiment of the invention does not necessarily achieve each and every object of the invention.

The preferred embodiment of the present invention is illustrated in the drawings and examples. However, it should be expressly understood that the present invention should not be limited solely to the illustrative embodiment.

### BRIEF DESCRIPTION OF THE DRAWINGS

FIG. 1 is a schematic drawing of a laser according to the invention

FIG. 2 is a partial plan view of the laser of FIG. 1.

FIG. 3 is a schematic view of the temperature control system for the amplifier medium according to the invention.

FIG. 4A is a side perspective of the amplifier media cooling assembly according to the invention.

FIG. 4B is a bottom perspective of the amplifier media cooling assembly according to the invention.

FIG. 5A is a graphical representation of a temporal pulse according to the invention.

FIG. 5B is a graphical representation of a transverse mode according the invention.

FIG. 6 is a graph showing the effect of temperature of the amplifier on the power output of the laser according to the invention.

### DETAILED DESCRIPTION OF THE INVENTION

According to the invention a pulsed laser is provided. The laser includes a Q-switched seed laser lasing at a preselected wavelength at TEM₀₀ mode having a mode quality M²<2 providing a pulsed seed beam having a power of from 0.1 to 50 watts, desirably 1 to 25 watts. Preferably the seed beam is pulsed in a single longitudinal mode. Desirably the seed laser is a Nd:YAG laser supplying a seed beam having a power of 1 to 25 watts. Optionally a fiber laser or a solid state laser other than Nd:YAG for example Nd:YVO₄ is used. Desirably the laser is operated at a high repetition rate of 1 Khz to 300 Khz desirably 1 to 150 Khz, desirably 1 to 150 Khz for example 10 to 50 Khz.

One or more substantially non-depolarizing Nd:YVO₄, or Nd:GVO₄ optical amplifier media crystals preferably Nd:YVO₄ crystals are provided in optical communication with the seed laser. Preferably two or more optical amplifier media desirably four to eight for example four optical amplifier media are used. Preferably the laser is configured for single pass operation. The optical amplifier media has a stimulated emission spectrum overlapping the preselected wavelength of the seed laser. A pumping source for example diodes preferably diode arrays is provided in optical communication with the optical amplifier media to supply 15 watt or more of pumping power to excite the amplifier media and amplify the pulsed seed beam. Preferably 15 watts to 100 watts of pumping power is supplied to each optical amplifier media, desirably 20 to 60 watts. Desirably the amplifier crystals are end pumped. The resulting laser produces 15 watts or greater of output power at the preselected wavelength. Desirably about 10 or more watts per optical amplifier medium of output power is obtained. The laser according to the invention can desirably produce a pulsed high power beam having a single longitudinal mode. The laser is simple, efficient and more reliable than multipass configurations while still generating a pulsed high power output.

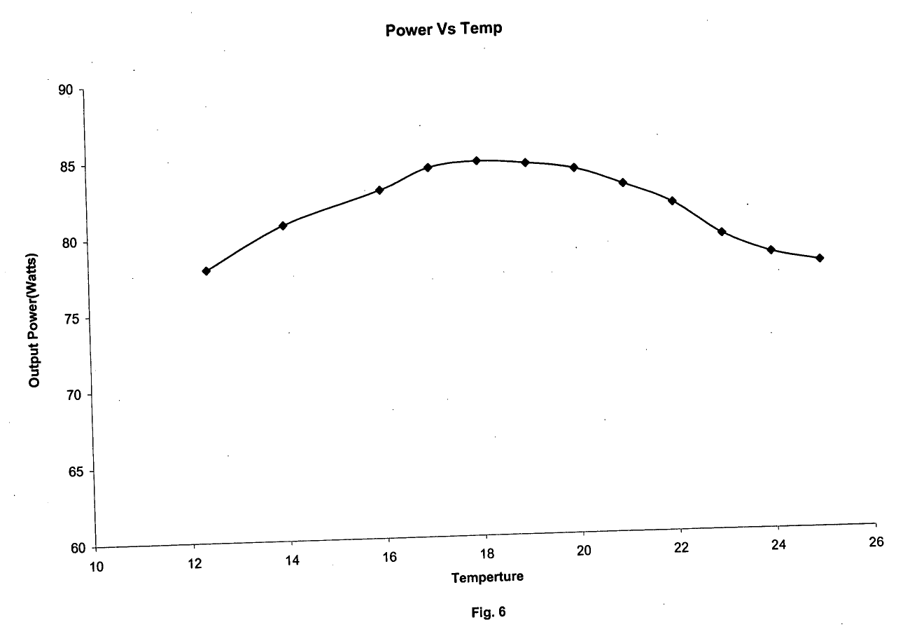

In another aspect of the invention, a temperature controller is provided to regulate the temperature of the optical amplifier medium within a preselected range selected to enhance the amplification of the seed beam by increasing the degree of overlap between the stimulated emission spectrum and the seed beam wavelength. As seen in FIG. 6 control of the temperature of the crystal within a desired range of a few degrees or less preferably within 1° C. desirably within 0.5° C. can improve efficiency and increase power output. The amplifier media can be directly or indirectly cooled.

Preferably, when a crystal lasing medium is used as the seed laser, the laser crystal temperature is preferably controlled. The laser can be directly or indirectly cooled as is common in the art. The temperature is controlled so that that the wavelength of the beam propagating from the seed laser is adjusted slightly to enhance the degree of overlap between the stimulated emission spectrum of the amplifier media and the seed beam.

Desirably a collimator is provided along the path of amplified beam prior to its receipt by the next amplifier. The collimator desirably serves three purposes. First the thermal lensing effects in an optical amplifier can be substantially compensated for by collimating the beam propagating from the previous amplifier medium prior to its passing into the next amplifier medium. Second, in addition to compensating for the thermal lensing effect, the collimating optics desirably can shape the seed beam so that there is good mode matching between the pumping beam and seed beam in order to have maximum amplification efficiency. Third the collimator adjusts the spot size of the amplified beam to obtain a preferred beam intensity in the amplifier medium. Preferably a collimator is provided in optical communication with each optical amplifier media along the path of the amplified beam prior to its receipt by the next amplifier medium. The collimator can be a lens or a curved mirror, multiple curved mirrors multiple lenses or combination of mirrors and lenses provided in optical communication with one or more of the optical amplifier media. Optionally, the collimator can be provided at one or both ends of the crystal amplifier media by grinding a concave curvature on one or both ends of the crystal. One of the objectives of the collimator is to substantially mode match the seed beam and the diode pumping beam in the end pumped system. The seed beam spot size in the amplifier medium is designed such that the intensity of the seed beam is preferably within 10¹ to 10⁵ times the saturation intensity of said amplifier medium where the saturation intensity equals to Iₛₐₜ=h/(₂₁*_{f}) for a four level laser system such as Nd:YVO₄ or Nd:GVO₄. For example, saturation intensity for the Nd:YVO₄ amplifier medium is approximately of 1.3×10³ Watts/cm². With the seed beam intensity within the range of 10¹ to 10⁵ desirably 10² to 10⁴ times saturation intensity, the single pass of the seed beam will be effective to extract a substantial amount of the available gain stored in the amplifier medium. More than one pass to the amplifier medium would not produce a meaningful power gain under such conditions and detrimentally complicate the design of the overall system. Depending on its mode and shape, the initial seed beam is preferably subjected to collimating optics to achieve the desired beam intensity in the first amplifier medium and to mode match the pump beam.

The resulting laser has a pulsed high power output of 15 watts or greater preferably 50 watts or more desirably 100 watts or more at TEM₀₀ mode having little mode distortion. Desirably the output beam has a single longitudinal mode. Depolarization problems commonly encountered with Nd:YAG lasers are substantially avoided. Simple single pass systems are provided having a pulsed high power output.

In another aspect of the invention, a system for providing a pulsed high power laser having modular amplifiers where the power output can be raised substantially proportional to the number of added amplifier modules is provided. Desirably the power output is 10 watts or more preferably 15 to 20 watts or more per amplifier module. The laser includes a Q-switched seed laser providing a pulsed seed beam having a preselected wavelength at TEM₀₀ mode having a mode quality M²<2 on a single pass seed beam path. A first and a second or more additional amplifier modules desirably four or more are provided. Each amplifier module has a non-depolarizing Nd:YVO₄ or Nd:GVO₄ optical amplifier crystal for receiving pulsed seed beam at an inlet end and delivering an amplified seed beam to an outlet end. The optical amplifier crystal has a stimulated emission spectrum overlapping the seed laser wavelength. A pumping source is provided in optical communication with the optical amplifier crystal to supply 15 watts or more of pumping power to excite the optical amplifier crystal and amplify the seed beam. The first amplifier module is located on the seed beam path to receive and amplify the seed beam and to deliver the amplified seed beam on a first module outlet path. The second amplifier module is located on the first module outlet path to receive and amplify the amplified seed beam from the first module in a single pass through the second module and deliver an amplified seed beam on a second module outlet path. A collimator is located along the first modular outlet path at a location along the path so that the amplified seed beam goes through the collimator before the amplified seed beam passes through the optical amplifier crystal. Each additional amplifier module is located on the module outlet path of the preceding amplifier module to receive and amplify the amplified seed beam from the preceding module in a single pass through the additional module and deliver an amplified seed beam on an additional module outlet path. Additional collimators for each additional amplifier module are located along the modular outlet path of the preceding amplifier module at a point before the amplified seed beam passes through the optical amplifier crystal to collimate the additional amplified seed beam. The final additional amplifier module outlet path is usually the outlet path of the laser. In a two module system, the final additional module is the second module. Preferably, according to the invention a pulsed high power laser having four or more desirably four to eight amplifier modules are provided having an output power of 80 watts or more desirably 100 watts or more. Desirably It is an object of the invention to provide a simple modular amplifier that can have its power raised substantially proportional to the number of modules.

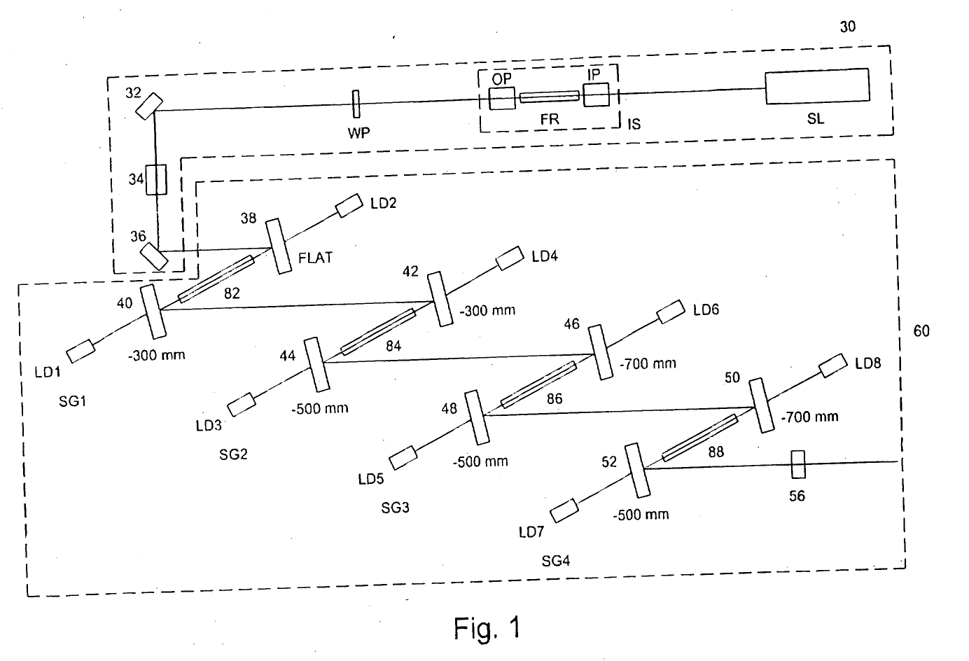

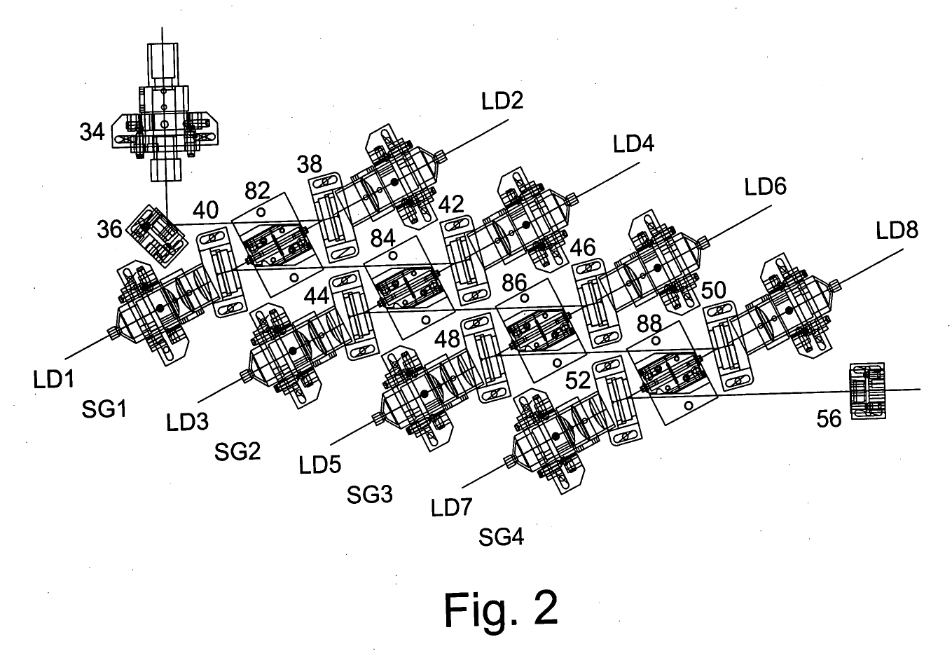

Referring to FIG. 1 and FIG. 2, a single pass laser according to the invention is provided. A seed laser assembly 30 is provided. The seed laser assembly includes a seed laser desirably a fiber laser or crystal laser preferably a Nd:YAG laser SL lasing at 1064.2 nm having a power output of 10 watts at TEM₀₀ mode and desirably having a single longitudinal mode preferably at about 1064.2 nm at a repetition rate of 10 Khz. The beam propagating from laser SL is directed to an isolator which desirably includes a Faraday rotator FR, an input polarizer IP and an output polarizer OP. A half wave plate WP is provided in optical communication with the beam propagating from the isolator IS. Optionally a folding mirror 32 directs the beam propagating from the wave plate WP to optional collimating optics 34. Desirably collimating optics 34 is one or more lenses desirably two (2) as best seen in FIG. 2. The beam propagating from the collimating optics is directed to folding mirror 36 and reflected outside the seed laser assembly 30 to flat mirror 38 for introduction into a beam amplifier. Collimating optics 34 collimates the seed beam to mode match the seed beam with the pump beams from diodes LD1 and LD2 where the mode size is determined by seed beam intensity, pumping beam intensity and amplifier medium's staturation intensity in order to efficiently convert the pumping power to the amplifying power.

The laser amplifier according to the invention includes one or more substantially non-depolarizing optical crystals for example one or more Nd:YVO₄, or Nd:GVO₄ crystals preferably one or more Nd:YVO₄ crystals are provided in optical communication with the seed laser SL to provide a single pass of seed beam to each optical amplifier media. Preferably two or more optical amplifier media desirably four to eight for example four optical amplifier media having a stimulated emission spectrum overlapping the wavelength of the seed laser 30 are provided in a single pass configuration. As shown in FIGS. 1 and 2, four Nd:YVO₄ crystals 82, 84, 86 and 88 are desirably used. The stimulated emission spectrum of Nd:YVO₄ crystals includes 1064.2 nm wavelength of the seed beam. There is substantial overlap between the stimulated emission spectrum of the Nd:YVO₄ crystals and the 1064 nm seed beam.

According to the invention, the mirror 36 directs the seed laser beam into the amplifier 60 which has four stages or modules SG1, SG2, SG3, and SG4 for a single pass through each module. Each module includes a Nd:YVO₄ crystal and reflective surfaces and a pumping source. Flat mirror 38 is provided in optical communication with mirror 36 and the first module optical media preferably Nd:YVO₄ crystal 82. At the opposite end of first module optical media 82, a beam collimator is provided. Desirably the thermal lensing effects in the Nd:YVO₄ crystal is substantially compensated for by collimating the beam propagating from the amplifier medium 82. Desirably, the collimator also provides the desired amplified seed beam diameter for the next amplifier stage. Thus, for example a negative lens or a convex mirror or multiple lenses and/or mirrors can be provided in optical communication with one or more preferably each optical amplifier crystal. Optionally, a collimator is provided at one or both ends of the amplifier crystals by grinding a convex curvature on one or both ends of the amplifier crystal.

Preferably a convex mirror 40 having for example a curvature of −300 mm is provided. In optical communication with amplifier crystal 82. Desirably the mirror 40 acts as a reflector to reflect beam from the first amplifier module SG1 as amplified seed beam to the next amplifier module. Mirror 40 is reflective preferably highly reflective for seed beam wavelength of 1064 nm and transmissive preferably highly transmissive for pump beam wavelength 808 nm. A pumping source preferably an end pumping source for example diodes is provided in optical communication with the optical amplifier media 82 to supply 15 watts or more of pumping power to excite amplifier media 82 and amplify the pulsed seed beam in a single pass. Preferably 15 watts to 100 watts of pumping power is supplied to each optical amplifier media, desirably 20 to 60 watts. As best seen in FIGS. 1 and 2, fiber coupled diode arrays LD1 and LD2 are provided in optical communication with mirrors 40 and 38 respectively to end pump optical amplifier 82 at about 25 watts from each end at a wavelength of about 808 nm for 50 watts of pumping power.

Second amplifier module SG2 is provided in optical communication with the first amplifier module SG1. Prior to the amplified beam propagating from optical amplifier medium 82 passes through the second module optical amplifier medium 84, the amplified beam incidents on a collimator. The collimator can be a lens or a curved mirror, multiple curved mirrors, multiple lenses or combination of mirrors and lenses provided in optical communication with one or more of the optical amplifier media. Optionally, the collimator can be provided at one or both ends of the crystal amplifier media by grinding a concave curvature on one or both ends of the crystal. Desirably the second module collimator is the combination of collimator convex mirror 42 having a curvature of −300 mm and convex mirror 40 having for example a curvature of −300 mm in optical communication with one another. Desirably convex mirror 44 having a curvature of −500 mm is provided in optical communication with mirror 42. Amplifier media 84 is located between mirrors 42 and 44. Both collimator mirrors 42 and 44 are reflective preferably highly reflective for seed beam wavelength here 1064 nm and transmissive preferably highly transmissive for pump beam wavelength 808 nm. A pumping source for example diodes is provided in optical communication with the optical amplifier media 84 to supply 15 watts or more of pumping power to excite amplifier media 84 and amplify the pulsed seed beam from first amplifier module SG1 which makes a single pass through amplifier media 84. Diodes LD3 and LD4 are provided in optical communication with mirrors 44 and 42 respectively to end pump optical amplifier 84 at 25 watts from each end at a wavelength of about 808 nm for 50 watts of pumping power. Collimator mirrors 40 and 42 substantially mode match the beam propagating from the amplifier medium 82 with pump beam from diode arrays LD3 and LD4 as well as compensating for the thermal lensing effects of the first amplifier crystal on the amplified beam and preferably providing an amplified seed beam having and an intensity within the range of 10¹ to 10⁵ desirably 10² to 10⁴ times saturation intensity.

Third amplifier module SG3 is provided in optical communication with the second amplifier module SG2. Prior to the amplified beam propagating from optical amplifier medium 84 passing through the third module optical amplifier medium 86, the amplified beam passes through a collimator. The collimator can be a lens or a curved mirror, multiple curved mirrors, multiple lenses or combination of mirrors and lenses provided in optical communication with one or more of the optical amplifier media. Optionally, the collimator can be provided at one or both ends of the crystal amplifier media by grinding a concave curvature on one or both ends of the crystal. Desirably the beam collimator is the combination of collimator convex mirror 44 having a curvature of −500 mm and convex mirror 46 having for example a curvature of −700 mm in optical communication with one another. Mirror 44 directs the amplified beam propagating from optical amplifier media 84 as seed beam to third amplifier module SG3. Desirably convex mirror 48 having a curvature of −500 mm is provided in optical communication with mirror 46. Amplifier media 86 is located between mirrors 46 and 48. Both mirrors 46 and 48 are reflective preferably highly reflective for seed beam wavelength of 1064 nm and transmissive preferably highly transmissive for pump beam wavelength 808 nm. A pumping source for example diodes is provided in optical communication with the optical amplifier media 86 to supply 15 watts or more of pumping power to excite amplifier media 86 and amplify the pulsed beam from SG2 in a single pass. Diodes LD5 and LD6 are provided in optical communication with mirrors 46 and 48 respectively to end pump optical amplifier 86 at about 25 watts from each end at a wavelength of about 808 nm for 50 watts of pumping power. Collimator mirrors 44 and 46 also mode match the beam propagating from the amplifier medium 84 with pump beam from diode arrays LD5 and LD6 as well as compensating for the thermal lensing effects of the second amplifier crystal on the amplified beam and preferably providing an amplified seed beam having and an intensity within the range of 10¹ to 10⁵ desirably 10² to 10⁴ times saturation intensity.

Fourth amplifier module SG4 is provided in optical communication with the third amplifier module SG3. Prior to the amplified beam propagating from optical amplifier medium 86 passing through the fourth module optical amplifier medium 88, the amplified beam incidents on a collimator. The collimator can be a lens or a curved mirror, multiple curved mirrors, multiple lenses or combination of mirrors and lenses provided in optical communication with one or more of the optical amplifier media. Optionally, the collimator can be provided at one or both ends of the crystal amplifier media by grinding a concave curvature on one or both ends of the crystal. Desirably the beam collimator is the combination of collimator convex mirror 48 having a curvature of −500 mm and convex mirror 50 having for example a curvature of −700 mm in optical communication with one another. Desirably convex mirror 52 having a curvature of −500 mm is provided in optical communication with mirror 50 Amplifier media 88 is located between mirrors 50 and 52. Both mirrors 50 and 52 are reflective preferably highly reflective for seed beam wavelength here 1064 nm and transmissive preferably highly transmissive for pump beam wavelength 808 nm. A pumping source for example diodes is provided in optical communication with the optical amplifier media 88 to supply 15 watts or more of pumping power to excite amplifier media 54 and amplify the pulsed beam from stage 3. Diodes LD7 and LD8 are provided in optical communication with mirrors 52 and 50 respectively to end pump optical amplifier 88 at 25 watts from each end at a wavelength of about 808 nm for 50 watts of pumping power. Collimator mirrors 48 and 50 also mode match the beam propagating from the amplifier medium 88 with pump beam from diode arrays LD7 and LD8 as well as compensating for the thermal lensing effects of the third amplifier crystal on the amplified beam and preferably providing an amplified seed beam having and an intensity within the range of 10¹ to 10⁵ desirably 10² to 10⁴ times saturation intensity.

Collimating optics desirably a convex lens 56 is provided in optical communication with mirror 52 and collimates the beam from the fourth stage and directs amplified beam outside the amplifier.

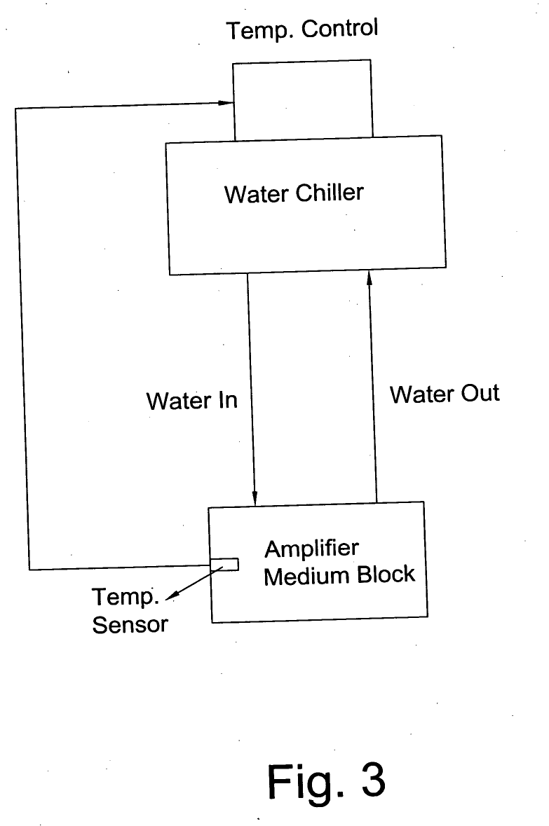

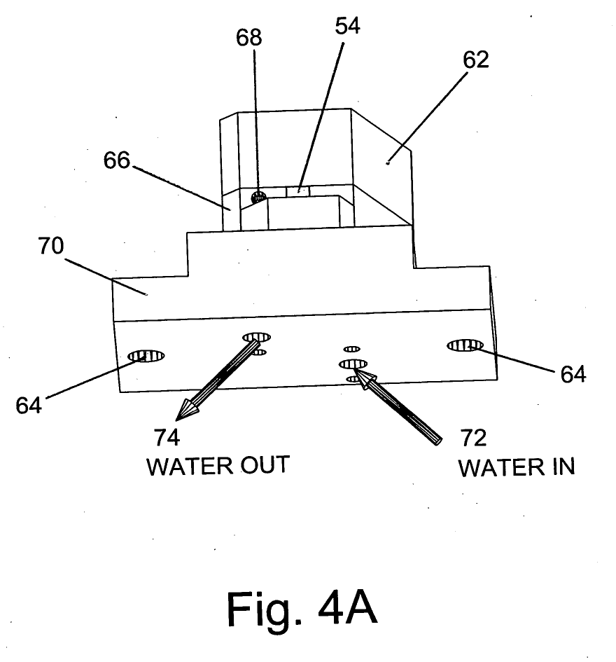

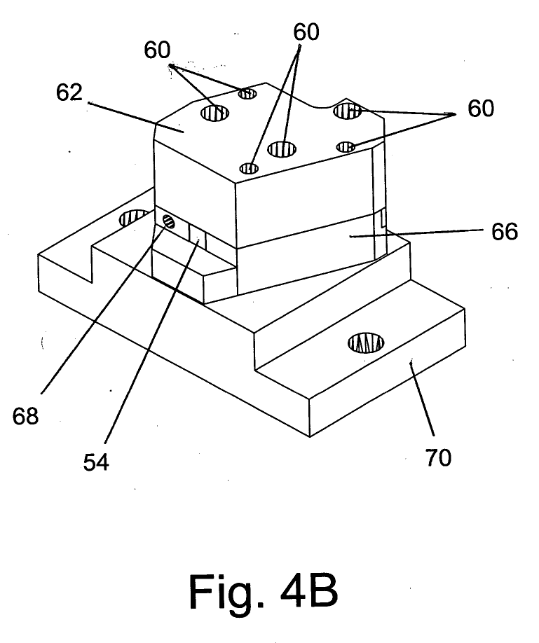

As best seen in FIGS. 3 and 4, the temperature of the crystal amplifiers 54 is controlled. As best seen in FIG. 6, the power output of the laser according to the invention varies with the temperature of the amplifier crystals. Thus, the temperature of the amplifier crystals is desirably controlled preferably within a narrow range preferably 1° C. or less desirably about 0.5° C. According to the invention, the crystal amplifiers are cooled either directly or indirectly. Since heat is generated during the amplification process, the temperature control of the amplifier media 54 requires the media to be cooled.

FIGS. 3 and 4 show a desirable indirect cooled embodiment. As best seen in schematic view of FIG. 3, the amplifier crystal is mounted in a thermally conductive preferably copper amplifier medium block. The crystal desirably at least partially contacts the block so there is a conductive thermal relationship between the block and the crystal. Desirably the crystal is wrapped in a conductive foil desirably in indium foil which is a highly thermally conductive material and allows more uniform thermal conductivity between the crystal and thermally conductive amplifier medium block. The wrapped crystal contacts the amplifier medium block. The block is connected to a chiller. A cooling liquid desirably cooling water is sent to the amplifier medium block, travels through conduits in the block to cool the block. The liquid preferably water is then either sent to a drain or preferably back to the chiller. A temperature controller is provided to control the temperature of the water supplied by the chiller. A temperature sensor 68 is provided to monitor the temperature of the amplifier crystal either directly or indirectly and to detect changes in temperature of the crystal. An output power sensor is also optionally provided to detect the power output of the laser. The temperature sensor can directly monitor the crystal temperature, the amplifier medium block temperature or optionally the temperature of the cooling water exiting the amplifier medium block. Preferably, the laser is tested after assembly at various crystal temperatures to determine the effect of temperature of the crystal on the power output. All or some of the crystals are temperature monitored desirably the last crystal for example the crystal in the stage 4 module SG4. A power output/crystal temperature relationship as seen in FIG. 6 is then preferably ascertained and a target power output and a corresponding desired crystal temperature is selected preferably to maximize power output. In use the crystal temperature is sensed and compared to the desired temperature and the temperature controller maintains, increases or decreases the temperature of the water supplied by the chiller depending on the difference between the sensed temperature and the desired temperature to maintain raise or lower the crystal temperature as desired.

Referring to FIGS. 4A and 4B, the amplifier crystals 54 preferably wrapped in a conductive material desirably a foil preferably indium foil are each mounted in an amplifier medium block 70. The block 70 includes a crystal mount top 62 and a crystal mount bottom 66 which receives and surrounds amplifier crystal 54. The crystal mount top 62 and crystal mount bottom 66 are made of a thermally conductive material preferably copper and surrounds and conductively contacts the amplifier crystal 54 preferably through the indium foil wrapping. Water conduits are provided through the crystal mount top 62 and bottom 66. Water is provided to the conduits through inlet 72 from a chiller, travels through the conduits in the crystal mount top and bottom 62 and 66. The chilled water cools the crystal mount top and bottom. Since the amplifier crystal 54 is in thermally conductive contact with the thermally conductive copper crystal mount top and bottom, the cooled crystal mount cools the amplifier crystal. A temperature sensor is provided to monitor the temperature of the amplifier crystal 54 either directly or indirectly and to detect changes in temperature of the crystal. The sensor can directly contact the crystal 54, contact the crystal mount top 62 or bottom 66 or can optionally monitor the temperature of the cooling water exiting the crystal mount. Preferably a sensor 68 is provided in contact with the crystal mount top or bottom preferably adjacent the amplifier crystal 54. After assembly, the laser is operated and the relationship between power output and crystal temperature is developed.

FIG. 6 shows the relationship of temperature and power output for the laser of FIGS. 1 and 2. As shown in FIG. 6 for the device of FIG. 1 and FIG. 2, the maximum power output of about 85 watts occurs at about 18° and that temperature is chosen as the target temperature. Referring to FIG. 6, a temperature variation of 2° (from 18° to 16°) will result in a power output of only about 83 watts. The maximum power output temperature can vary depending on the actual wavelength of the seed beam. The temperature controller is programmed to vary the temperature of the chilled water to the amplifier medium block to raise or lower the temperature of the amplifier crystal when the sensed temperature differs from the target by more than a preselected amount for example by 0.5° C. Desirably the chilled water is raised or lowered in 0.1° C. increments. The initial temperature of the chilled water varies depending on the number of amplifier media used and the volume of water supplied by the chiller.

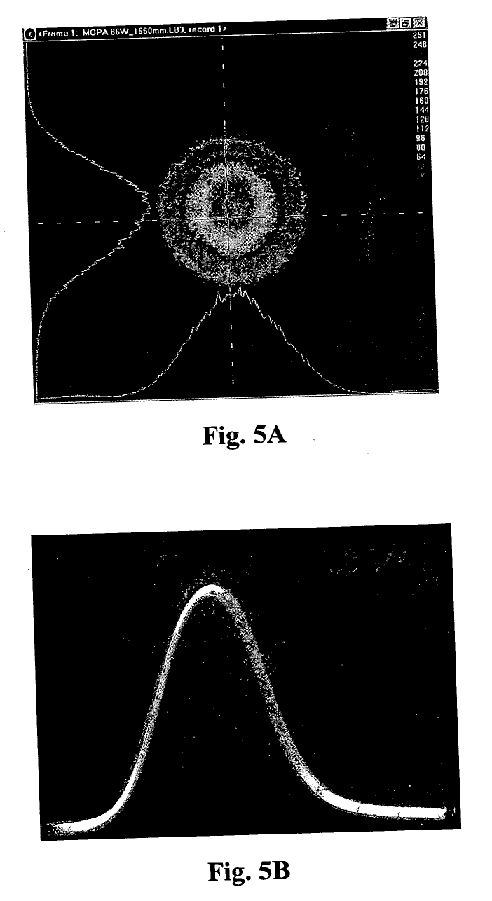

The resulting output beam of FIG. 1 has a power of over 80 watts at TEM₀₀ mode and having a single longitudinal mode. As shown in FIG. 5B, the temporal profile reveals the output beam is a diffraction limited TEM₀₀ beam. FIG. 5A is beam intensity profile taken by Spiricon LBA-100 where it shows it is a perfect TEM₀₀ mode with diffraction limited intensity distribution. And FIG. 5B indicates the temperal pulse profile at about FWHM of 55 nanosecond where the laser is at 10 kHz in repetition rate.

The foregoing is considered as illustrative only to the principals of the invention. Further, since numerous changes and modification will occur to those skilled in the art, it is not desired to limit the invention to the exact construction and operation shown and described above, and accordingly, all suitable modifications and equivalents may be resorted to, falling within the scope of the invention.

1. A laser comprising:
a) a Q-switched seed laser lasing at a preselected wavelength at TEM₀₀ mode having a mode quality M²<2 providing a pulsed seed beam on a single pass seed beam path;
b) one or more optical amplifier media; said optical amplifier media being a Nd:YVO₄ or Nd:GVO₄ crystal having a stimulated emission spectrum, said optical amplifier media in optical communication with said seed laser to produce an amplified beam;
c) said preselected wavelength overlapping said stimulated emission spectrum of said optical amplifier media;
d) a pumping source in optical communication with said optical amplifier media to supply 15 watt or more of pumping power to excite said medium and amplify said pulsed seed beam;
e) said amplified beam having 10 watts or greater of output power.

2. The laser according to claim 1 wherein said optical amplifier media is a Nd:YVO₄ crystal.

3. The laser according to claim 2 wherein said pulsed seed beam has a single longitudinal mode.

4. The laser according to claim 2 wherein said optical amplifier is end pumped by said pumping source.

5. The laser according to claims 2 wherein said seed laser is a fiber laser.

6. The laser according to any one of claims 2 to 4 wherein said seed laser is a Nd:YAG laser.

7. The laser according to any one of claims 2 to 4 wherein said seed laser is a Nd:YVO₄ laser.

8. The laser according to claim 2 further comprising an optical amplifier temperature regulator controlling said optical amplifier media temperature to enhance the amplification of said seed beam.

9. The laser according to claim 8 wherein said optical amplifier temperature regulator includes:
i) a temperature sensor to determine the temperature of said optical amplifier media;
ii) a chiller for cooling a liquid over a preselected temperature range; said chiller providing a cooled liquid at a cooled liquid temperature within said preselected temperature range;
iii) said chilled liquid temperature variable on receipt of a signal from said temperature sensor upon changes in the temperature of said optical amplifier media;
iv) said cooled liquid temperature varied to control the temperature of said optical amplifier media within a predetermined temperature range that enhances the power of said amplified beam.

10. The laser according to claim 9 wherein said predetermined temperature range is about 1° C. or less.

11. The laser according to claim 9 further comprising:
f) said optical amplifier media mounted to a thermally conductive housing;
g) said housing having a liquid channel therethrough, said liquid channel having a liquid inlet and outlet;
h) said chiller supplying liquid to said liquid inlet in said conductive housings;
i) said temperature sensor monitoring the temperature of the amplifier media either directly or indirectly.

12. The laser according to claim 11 said temperature sensor signals said chiller to adjust the temperature of said inlet liquid in response to the temperature of said amplifier media, liquid flowing through said liquid outlet or the temperature of said thermally conductive housing to control the temperature of said amplifier media.

13. The laser according to claim 11 wherein said optical amplifier media is wrapped in indium foil.

14. The laser according to claim 13 wherein said liquid is water.

15. The laser according to claim 14 wherein said temperature sensor signals said chiller to adjust the temperature of said inlet water in response to the temperature of said thermally conductive housing to control the temperature of said amplifier media.

16. The laser according to claim 1 further comprising a collimator in optical communication with each optical amplifier media to collimate the seed beam into amplifier medium to ensure a substantial mode matching between the seed beam and pumping beam.

17. The laser according to claim 1 further comprising a collimator in optical communication with each optical amplifier media to collimate the seed beam into amplifier medium to ensure substantial mode matching between the seed beam and pumping beam and to compensate for thermal lensing effects in amplified beam.

18. The laser according to claim 1 further comprising a collimator in optical communication with each optical amplifier media to collimate said seed beam into the amplifier medium where it ensures the substantial mode matching between the seed beam and pumping beam and form the seed beam having a seed beam intensity within a range of 10¹ to 10⁵ times saturation intensity of the amplifier medium.

19. The laser according to claim 1 further comprising a collimator in optical communication with each optical amplifier media to collimate the seed beam into amplifier medium to ensure the substantial mode matching between the seed beam and pumping beam and form the seed beam where the seed beam intensity within at range of 10² to 10⁴ times saturation intensity of the amplifier medium.

20. A laser comprising:
a) a Q-switched seed laser providing a pulsed seed beam having a preselected wavelength at TEM₀₀ mode having a mode quality M²<2 on a single pass seed beam path;
b) a first and a second or more additional amplifier modules, said laser terminating in a final additional module;
c) each said amplifier module having
i) a non-depolarizing Nd:YVO₄ or Nd:GVO₄ optical amplifier crystal for receiving pulsed seed beam at an inlet end and delivering an amplified seed beam to an outlet end;
ii) said optical amplifier crystal having a stimulated emission spectrum overlapping said preselected wavelength;
iii) a pumping source in optical communication with said optical amplifier crystal to supply 15 watts or more of pumping power to excite said optical amplifier crystal and amplify said seed beam;
d) said first amplifier module located on said seed beam path to receive and amplify said seed beam and to deliver said amplified seed beam on a first module outlet path;
f) said second amplifier module located on said first module outlet path to receive and amplify said amplified seed beam from said first module in a single pass through said second module and deliver an amplified seed beam on a second module outlet path;
g) a collimator located along said first modular outlet path before said amplified seed beam passes through said optical amplifier crystal to collimate said amplified seed beam;
h) each said additional amplifier module located on the module outlet path of the preceding amplifier module to receive and amplify said amplified seed beam from the preceding module in a single pass through said additional module and deliver an amplified seed beam on an additional module outlet path;
i) an additional collimator for each additional amplifier module located along said modular outlet path of the preceding amplifier module before said amplified seed beam passes through said optical amplifier crystal to collimate said amplified seed beam;
j) said final additional amplifier module outlet path being the outlet path of the laser.

21. The laser according to claim 20 further comprising
k) a collimator located along said seed beam path before said seed beam passes through said optical amplifier crystal to collimate said seed beam.

22. The laser according to claim 20 further comprising
l) said laser producing 10 watts or greater of output power for each module.

23. The laser according to claim 20 wherein said seed laser is a Nd:YAG laser.

24. The laser according to claim 20 wherein said optical amplifier crystal is Nd:YVO₄ amplifier crystal.

25. The laser according to claim 20 wherein said collimator collimates the amplified seed beam to ensure a substantial mode match between the seed beam and pumping beam.

26. The laser according to claim 20 or 25 wherein said collimator forms a seed beam having seed beam intensity within a range of 10¹ to 10⁵ times saturation intensity of the amplifier medium.

27. The laser according to claim 20 or 25 wherein said collimator forms a seed beam having seed beam intensity within a range of 10² to 10⁴ times saturation intensity of the amplifier medium.

28. The laser according to claim 26 wherein thermal lensing occurs in said crystal, said collimator compensates for at least a portion of said thermal lensing.

29. The laser according to claim 20 wherein said collimator is a negative lens, a convex mirror, a convex curvature ground on one or both ends of said amplifier crystal or combination thereof.

30. The laser according to claim 20 wherein said collimator is one or more convex mirrors.

31. The laser according to claim 20 wherein said pulsed seed beam has a single longitudinal mode.

32. The laser according to claim 20 wherein said optical amplifier crystals are end pumped by said pumping source.

33. The laser according to claim 20 wherein said optical amplifier crystals are end pumped by said pumping source; said pumping source supplies 25 watts or more of pumping power to each module.

34. The laser according to claim 20 wherein said optical amplifier crystals are end pumped by said pumping source; said pumping source supplies 25 to 60 watts of pumping power to each module.

35. The laser according to claim 25 wherein said laser produces 10 watts or greater of output power for each module.

36. The laser according to claim 25 wherein said laser produces 15 watts or greater of output power for each module.

37. The laser according to claim 25 wherein said laser produces 20 watts or greater of output power for each module.

38. The laser according to claim 25 wherein said laser has four (4) modules and produces 80 watts or greater of output power.

39. The laser according to claim 20 further comprising an optical amplifier temperature regulator controlling said optical amplifier media temperature to enhance the amplification of said seed beam.

40. A laser according to claim 20 wherein said laser has a repetition rate of from 1 to 150 Khz.

41. A laser according to any one of claim 20 wherein said laser has a repetition rate of from 1 to 50 Khz.
